(19) United States
(12) Patent Application Publication
(10) Pub. No.: US 2021/0125090 A1
(43) Pub. Date: Apr. 29, 2021

(54) ABDUCTIVE INFERENCE DEVICE, ABDUCTIVE INFERENCE METHOD, AND COMPUTER-READABLE MEDIUM

(71) Applicant: NEC Corporation, Minato-ku, Tokyo (JP)

(72) Inventors: Yoichi SASAKI, Tokyo (JP); Kazeto YAMAMOTO, Tokyo (JP); Kunihiko SADAMASA, Tokyo (JP); Takanori MAEHARA, Saitama (JP); Takumi AKAZAKI, Saitama (JP)

(73) Assignee: NEC Corporation, Minato-ku, Tokyo (JP)

(21) Appl. No.: 17/254,945

(22) PCT Filed: Feb. 18, 2019
(86) PCT No.: PCT/JP2019/005725

§ 371 Date: Dec. 22, 2020

(30) Foreign Application Priority Data
Jun. 25, 2018 (JP) 2018-119771

(51) Int. Cl. G06N 5/04; G06N 20/00

(52) U.S. Cl. CPC G06N 5/04; G06N 20/00

(57) ABSTRACT

The abductive inference device includes a hypothesis generation unit for creating a set of candidate hypotheses, observed information including a hypothesis from which a logical expression is derived based on a knowledge database including knowledge information expressing the logical expression for deriving a consequent from an antecedent, a conversion unit for calculating a constraint condition for the created set of candidate hypotheses and a weight for the constraint condition in accordance with predetermined processing; and a solver unit for calculating a hypothesis when a predetermined condition is satisfied based on the calculated constraint condition and the calculated weight.

### TECHNICAL FIELD

The present disclosure relates to an abductive inference device, an abductive inference method, and a computer-readable medium for creating an abduction.

### BACKGROUND ART

An example of an abductive inference processing method is described in Non Patent Literature 1. As shown in FIG. 10, the abductive inference processing method includes means for generating a set of candidate hypotheses, and means for selecting, from the set of candidate hypotheses, the candidate hypothesis which can explain an observation logical expression most appropriately without excess or deficiency by evaluating the probability of each candidate hypothesis. The abductive inference processing method receives, as inputs, an observation logical expression (observation) and a knowledge base (background knowledge) and outputs a best hypothesis as an explanation of the observation logical expression. In the abductive inference processing method, observation logical expressions are provided with parameters (costs) indicating “which piece of observation information is important”. Inference knowledge (axiom) is stored in the knowledge base, and each piece of inference knowledge is provided with a parameter (weight) indicating “the reliability of the antecedent holding true when the consequent holds true”. Also, evaluation values (evaluations) are calculated in consideration of these parameters in the evaluation of the probability of a candidate hypothesis. According to such a method, it is possible to generate an explanation that can better and more simply explain the observation logical expression.

For example, assume that a logical expression that indicates the information “Criminal A and Police officer B are present, and these two people are in the same police car” is given as an observation logical expression. Further assume that as a knowledge base, the inference knowledge indicates pieces of knowledge, such as “if x arrests y, then x is a police officer and y is a criminal”, “an arrested person gets in a police car”, and “a police officer gets in a police car”. At this time, it is expected that the abductive inference method applies each piece of inference knowledge in reverse to the observation logical expression through the procedure as shown in FIG. 10 and outputs a candidate hypothesis as a solution hypothesis as shown in FIG. 11. That is, it is shown that all pieces of observation information can be deductively derived from the hypothesis using the background knowledge only if the hypothesis of “B arrested A” is assumed. More specifically, the observation logical expression can be explained by the candidate hypothesis “B arrested A” without excess or deficiency.

### CITATION LIST

### Non Patent Literature

Non Patent Literature 1: Naoya Inoue and Kentaro Inui. ILP-based Reasoning for Weighted Abduction. In Proceedings of AAAI Workshop on Plan, Activity and Intent Recognition, pp. 25-32, August 2011.
Non Patent Literature 2: Vasco Manquinho, Joao Marques-Silva, Jordi Planes. Algorithms for Weighted Boolean Optimization, International Conference on Theory and Applications of Satisfiability Testing, pp. 495-508, 2009.
Non Patent Literature 3: Naoya Inoue and Kentaro Inui. Large-scale Cost-based Abduction in Full-fledged First-order Predicate Logic with Cutting Plane Inference. In Proceedings of the 13th European Conference on Logics in Artificial Intelligence (JELIA), pp. 281-293, September 2012
Non Patent Literature 4: Dowling, William F and Gallier, Jean H, Linear-time algorithms for testing the satisfiability of propositional Horn formulae, The Journal of Logic Programming, pp. 267-284, 1984.
Non Patent Literature 5: Williams, Ryan and Gomes, Carla P and Selman, Bart, Backdoors to typical case complexity, IJCAI, pp. 1173-1178, 2003.
Non Patent Literature 6: “Open-WBO product information”, the Internet: <http://sat.inesc-id.pt/open-wbo/>
Non Patent Literature 7: October Sky Co., Ltd. “Gurobi Optimizer product information”, the Internet <https://www.octobersky.jp/products/gurobi.html>
Non Patent Literature 8: “SCIP product information”, the internet: <http://scip.zib.de/>

### SUMMARY OF INVENTION

### Technical Problem

There has been a problem in the abductive inference processing method disclosed in Non Patent Literature 1 that it takes a long processing time to acquire a hypothesis in a system that uses big data or repeats inference a plurality of times. An object of the present disclosure is to provide an abductive inference device and the like capable of calculating a hypothesis in a short time.

### Solution to Problem

The present disclosure is an abductive inference device including: a hypothesis generation unit for creating a set of candidate hypotheses, observed information including a hypothesis from which a logical expression is derived based on a knowledge database including knowledge information expressing the logical expression for deriving a consequent from an antecedent; a SAT conversion unit for calculating a constraint condition for the created set of candidate hypotheses and a weight for the constraint condition in accordance with predetermined processing; and a solver unit for calculating a hypothesis when a predetermined condition is satisfied based on the calculated constraint condition and the calculated weight.

Further, the present disclosure is an abductive inference method including: a first step of creating a set of candidate hypotheses, observed information including a hypothesis from which a logical expression is derived based on a knowledge database including knowledge information expressing the logical expression for deriving a consequent from an antecedent; a second step of calculating a constraint condition for the created set of candidate hypotheses and a weight for the constraint condition in accordance with predetermined processing; and a third step of calculating a hypothesis when a predetermined condition is satisfied based on the calculated constraint condition and the calculated weight.

Furthermore, the present disclosure is a program causing a computer to execute: a first step of creating a set of candidate hypotheses, observed information including a hypothesis from which a logical expression is derived based on a knowledge database including knowledge information expressing the logical expression for deriving a consequent from an antecedent; a second step of calculating a constraint condition for the created set of candidate hypotheses and a weight for the constraint condition in accordance with predetermined processing; and a third step of calculating a hypothesis when a predetermined condition is satisfied based on the calculated constraint condition and the calculated weight.

### Advantageous Effects of Invention

According to the present disclosure, a hypothesis can be calculated in a short time.

### BRIEF DESCRIPTION OF DRAWINGS

FIG. 1 is a diagram for explaining an overview of the present disclosure;

FIG. 2 is a diagram for explaining an abductive inference method;

FIG. 3 is a flowchart showing an operation of the abductive inference device according to the first example embodiment;

FIG. 4 is an experimental result of an abductive inference device according to the example embodiment. Methods to be compared are algorithms described in Non Patent Literature 1;

FIG. 5 is a schematic diagram showing a set of candidate hypotheses;

FIG. 6 is a schematic diagram for explaining hypotheses and the assignment of truth values for respective variables;

FIG. 7 is a table showing truth values for respective Boolean variables;

FIG. 8 is a schematic diagram showing a configuration of an abductive inference device according to the second example embodiment;

FIG. 9 is a flowchart showing an operation of the abductive inference device according to the second example embodiment for implementing the present disclosure;

FIG. 10 is a schematic diagram for explaining a related abductive inference processing method; and

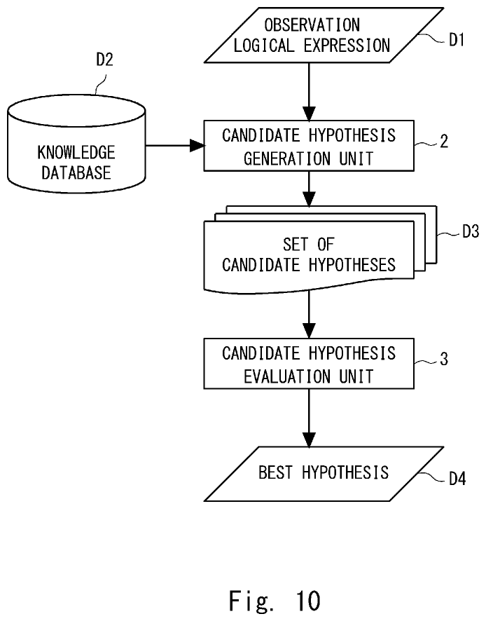

FIG. 11 is a schematic diagram for explaining a related abductive inference processing method.

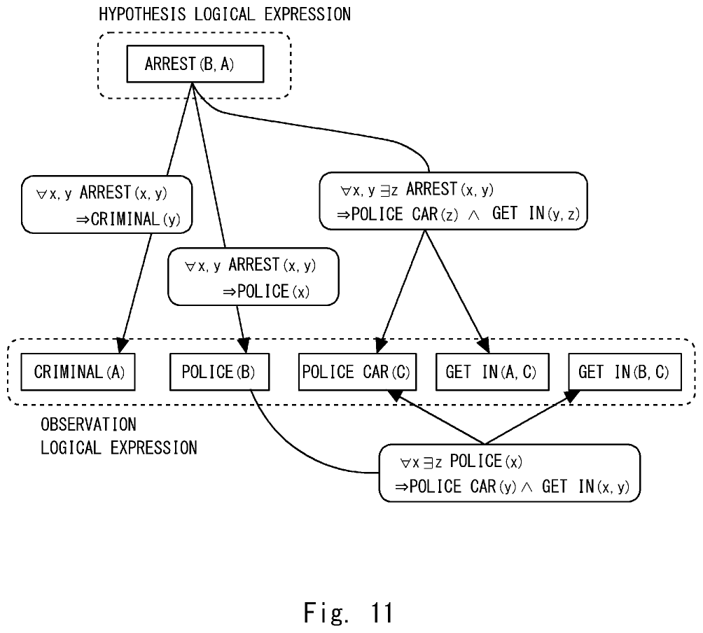

### DESCRIPTION OF EMBODIMENTS

Example embodiments of the present disclosure will be described in detail by way of examples with reference to the drawings. However, the components described in the following example embodiments are merely exemplary and are not intended to limit the scope of the disclosure to them.

### [Features of the Present Disclosure]

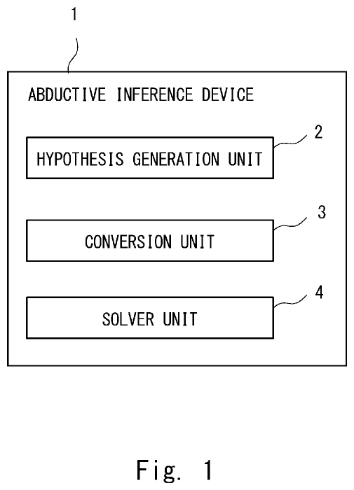

Prior to the description of the example embodiments of the present disclosure, an overview of the features of the present disclosure will be described first. FIG. 1 is a diagram for explaining an overview of the present disclosure. As shown in FIG. 1, an abductive inference device 1 according to the present disclosure includes a hypothesis generation unit 2, a conversion unit 3, and a solver unit 4.

The hypothesis generation unit 2 creates a set of candidate hypotheses in which observed information includes a hypothesis from which a logical expression is derived based on a knowledge database including knowledge information in which a logical expression for deriving a consequent from an antecedent is expressed. The conversion unit 3 calculates a constraint condition related to the created set of candidate hypotheses and a weight for the constraint condition in accordance with predetermined processing. The solver unit 4 calculates a hypothesis when a predetermined condition is satisfied based on the calculated constraint condition and the calculated weight. In this manner, the hypothesis can be calculated in a short time.

### First Example Embodiment

Hereinafter, a first example embodiment of the present disclosure will be described with reference to the drawings.

### [Description of Configuration]

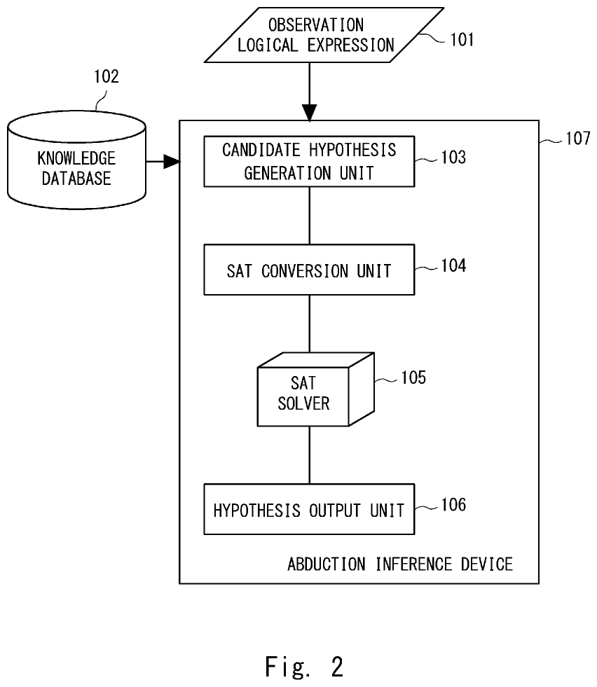

An abductive inference method performed by the abductive inference device according to the first example embodiment will be described with reference to FIG. 2. FIG. 2 is a schematic diagram showing a configuration of the abductive inference device according to the first example embodiment. In the abductive inference method performed by this abductive inference device, for example, a problem in deriving a best hypothesis from the set of candidate hypotheses generated in processing of abductive inference is converted into a Weighted Partial MaxSAT problem, and a hypothesis is created using a SAT solver. Since the Weighted Partial MaxSAT problem is disclosed in, for example, Non Patent Literature 2, the description of the Weighted Partial MaxSAT problem will be briefly described in this example embodiment, and a detailed description thereof will be omitted.

The MaxSAT (Maximum Satisfiability Problem) is a problem of finding the assignment of truth values to variables in a logical expression written in CNF (Conjunctive Normal Form) in such a way that the number of satisfied clauses becomes the largest. The truth value is expressed by, for example, numerical values of 1 (true value, true) and 0 (false value, false). CNF is a logical expression in the form of ∧∨x_{i,j} for the literal x_{i, j}. An AND operation is represented by “∧”. An OR operation is represented by “∨”. For example, a logical expression such as (A ∨ B) ∧ (¬B ∨ C ∨ ¬D) ∧ (D ∨ ¬E) is described in accordance with CNF.

Next, the Weighted MaxSAT is a problem of finding the assignment of a truth value in such a way that the sum of the weights of the satisified clauses becomes the largest for variables in a logical expression when the clauses in the logical expression written in CNF is weighted.

In this example embodiment, the weighted partial MaxSAT is an optimization problem including a clause (hard clause) that must be satisfied and a clause (soft clause) that is not necessarily satisfied, in comparison with the above-described weighted MaxSAT. This optimization problem is defined as follows, for example.

The Weighted Partial MaxSAT is a problem of acquiring an assignment I of a truth value in such a way that the sum of the weights of false clauses becomes minimum when the logical formula φ={(C1, w1), . . . , (Cm, wm), (Cm+1, ∞), . . . , (Cm+m′, ∞)} of CNF is given. Here, each element of φ represents information in which a clause and a weight for the clause are associated, m clauses (e.g., C1 to Cm) are soft, and m′ clauses (e.g., Cm+1 to Cm+m′) are hard. Further, “∞” conceptually represents that the weight is sufficiently larger than w1 to wm.

A SAT solver 105 is a device that outputs, for example, a solution (in this case, a hypothesis) to a problem in response to an input representing the problem such as the one described above. This processing can be realized, for example, by using a method disclosed in Non Patent Literature 4 and 5. Therefore, in this example embodiment, a detailed description of the processing is omitted.

As shown in FIG. 2, an abductive inference device 107 includes a candidate hypothesis generation unit 103, a SAT conversion unit 104, a SAT solver 105, and a hypothesis output unit 106. The abductive inference device 107 is connected to the knowledge database 102 to enable the exchange of data therebetween. The knowledge database 102 stores information representing a given rule (knowledge) on which a hypothesis is created.

The candidate hypothesis generation unit 103 receives, as inputs, an observation logical expression 101 and information stored in the knowledge database 102, and outputs a set of candidate hypotheses. The observation logical expression 101 is information in which observed information is expressed using a logical expression. Here, the set of candidate hypotheses represents a set including at least one hypothesis generated by applying a rule (i.e., a given rule that if an antecedent holds true, a consequent also holds true) in the knowledge database in reverse to the given observation logical expression. That is, the rule is a logical expression for deriving the consequent from the antecedent. Furthermore, the information stored in the knowledge database can be expressed as knowledge information in which the logical expression for deriving the consequent from the antecedent is expressed. For example, if the set of candidate hypotheses at a specified time is H′, new p(A) is added to the set of candidate hypotheses by applying the inference knowledge p(x)→q(x) in reverse to to a certain candidate hypothesis q(A) ⊆ H′. As a result, the set of candidate hypotheses H is updated to “H′ ∧ p(A)”. In this case, “p(x)” represents the antecedent. Further, “q (x)” represents the consequent. The “inference knowledge p(x)→q(x)” represents one rule. The “x” represents a variable in the rule.

The SAT conversion unit 104 converts the set of candidate hypotheses derived by the candidate hypothesis generation unit 103 into the Weighted Partial MaxSAT problem, and inputs the result to the SAT solver 105.

The hypothesis output unit 106 outputs the best hypothesis from the result acquired by the SAT solver 105.

For convenience of explanation, the term “best” is used in each example embodiment, but the term “best” may not necessarily indicate the best. The more likely a hypothesis is to hold true, the better it is. Conversely, the less likely a hypothesis is to hold true the worse it is.

### [Description of Operation]

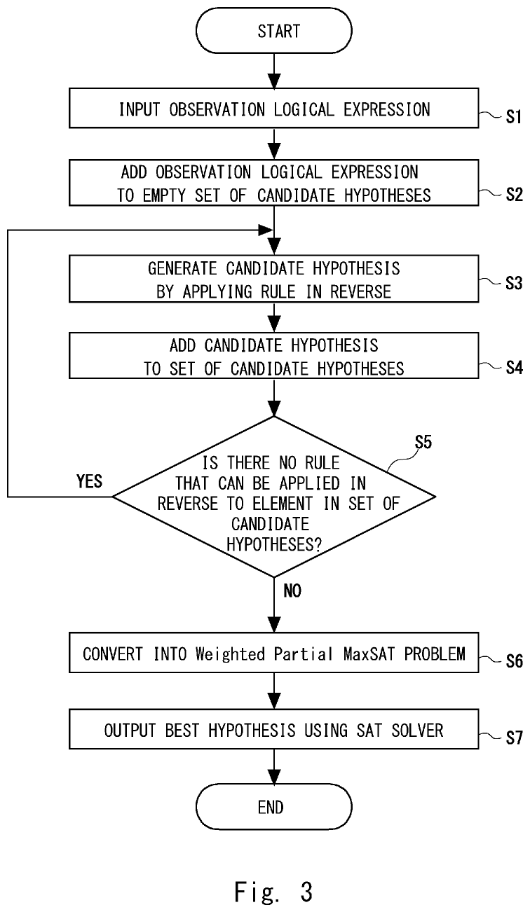

FIG. 3 is a flowchart showing an operation of the abductive inference device according to the first example embodiment.

As shown in FIG. 3, first, the candidate hypothesis generation unit 103 accepts an observation logical expression as an input (Step S1). Next, the candidate hypothesis generation unit 103 adds the observation logical expression to the set of candidate hypotheses (Step S2). The set of candidate hypotheses may be stored in, for example, a storage unit (not shown). It is also assumed that the set of candidate hypotheses is initialized in advance by an empty set.

Next, the candidate hypothesis generation unit 103 generates a candidate hypothesis by applying the rule in reverse to the elements in the set of candidate hypotheses (Step S3). Note that the candidate hypothesis generation unit 103 may store information representing the created set of candidate hypotheses in the storage unit (not shown). Next, the candidate hypothesis generation unit 103 adds the generated candidate hypothesis to the set of candidate hypotheses (Step S4). The candidate hypothesis generation unit 103 inputs the created set of candidate hypotheses to the SAT conversion unit 104. That is, the hypothesis generation unit 103 creates a set of candidate hypotheses in which observed information includes a hypothesis from which the logical expression is derived based on the knowledge database including the knowledge information in which the logical expression for deriving the consequent from the antecedent is expressed.

Next, the candidate hypothesis generation unit 103 determines whether or not there is no longer a rule (i.e., knowledge) in the knowledge database that can be applied in reverse to the elements in the set of candidate hypotheses (or whether the set end condition is satisfied) (Step S5). If there is no longer a rule in the knowledge database that can be applied in reverse to the elements in the set of candidate hypotheses (in the case of NO), the process proceeds to the next Step S6, whereas if there is a rule(s) in the knowledge database that can be applied in reverse to the elements in the set of candidate hypotheses (in the case of YES), the process returns to Step S3.

Next, the SAT conversion unit 104 converts the acquired set of candidate hypotheses into the Weighted Partial MaxSAT problem (Step S6). The SAT conversion unit 104 inputs the converted information to the SAT solver 105. That is, the SAT conversion unit 104 calculates, in accordance with the predetermined processing illustrated in Example 1 and the like, a constraint condition (which will be described in detail in Example 1. Examples of the constraint condition include “¬(h_{q(y)}∧¬r_{q(y)})”) related to the created set of candidate hypotheses and a weight (which will be described in detail in Example 1. Examples of the weight include “cost(q(y)” and “∞”) for the constraint condition. The SAT solver 105 applies a SAT solver to the converted problem. As a result of this processing, the SAT solver 105 creates, for example, a best hypothesis. That is, the SAT solver 105 calculates the hypothesis when the predetermined condition is satisfied based on the calculated constraint condition and the calculated weight. The predetermined condition is, for example, a condition that minimizes or substantially minimizes the cost of the hypothesis. The predetermined condition may be that the cost for the hypothesis is lower than a certain threshold. The predetermined conditions are not limited to the above examples. Specifically, a hypothesis that is likely to hold true can be calculated by calculating a hypothesis when the SAT solver 105 satisfies the predetermined condition.

Next, the hypothesis output unit 106 outputs the best hypothesis created by the SAT solver 105, for example, to the outside (Step S7).

### [Description of Effects]

Next, the effects of this example embodiment will be described. Non Patent Literature 3 discloses that, when the number of logical terms is n in a set of candidate hypotheses on a first-order predicate logic, constraint expressions related to O(n³) transitive laws, which is an enormous number of transitive laws, are generated.

On the other hand, Patent Literature 4 and Non Patent Literature 5 describe that it is known that the SAT problem, in which CNF having a high proportion of Horn clauses in the clauses constituting the logical expression is used as an input, can be solved at a high speed. The Horn clause corresponds to the transitive law of the constraint expression generated for the set of candidate hypotheses of abductive inference.

The present inventor has found a rule that, when a hypothesis is created, the proportion of Horn clauses is high in the created hypothesis. The present inventor has found another rule that when a hypothesis is created, the processing time is shorter if the hypothesis is created in accordance with the above-described SAT problem. Thus, the present inventor has configured the respective components of the abductive inference device 107 so as to perform high-speed processing in accordance with the found rule. As a result, the abductive inference device 107 according to this example embodiment can generate hypotheses in a short time.

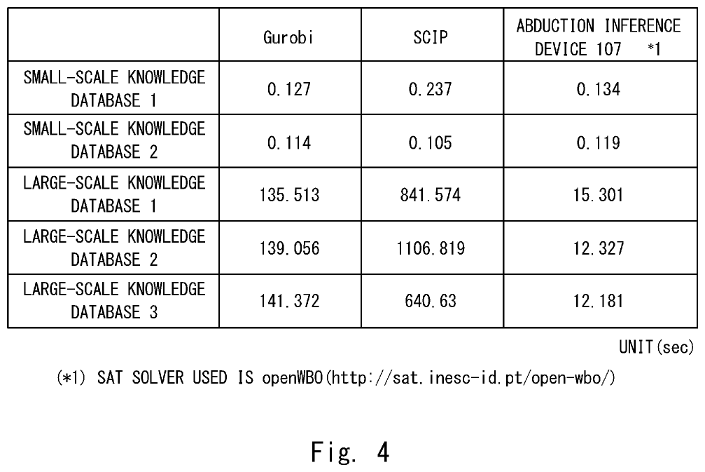

FIG. 4 shows experimental results of the abductive inference device 107 according to this example embodiment. The methods to be compared with are algorithms described in Non Patent Literature 1. The algorithm described in Non Patent Literature 1 converts a set of candidate hypotheses into an ILP (Integer Linear Programming) problem, and the ILP solver finds an optimum solution. In this case, Gurobi (see Non Patent Literature 7) and SCIP (see Non Patent Literature 8) are used as the ILP solvers.

On the other hand, the SAT solver used to implement this example embodiment is openWBO (see Non Patent Literature 6).

Both ILP and SAT problems are known to be NP-hard, but when applied to abductive inference, experimental results show that, in comparison to the methods to be compared, the SAT solver in this example embodiment is about 10 times faster than the Gurobi and about 100 times faster than SCIP for large knowledge databases. On the other hand, it can be seen that in this example embodiment, it is possible to perform an operation at a high speed at the same speed as that of the methods to be compared for small knowledge databases.

### EXAMPLE 1

The Weighted Abduction, one of typical abductive inferences, is described.

Examples of a knowledge database B and an observation logical expression O are shown below.

B(Rule)

r(x)→s(x),

s(x)∧t(y)→q(x)

O(query)

∀x, y q(y) [symbol] r(A) [symbol] s(x)

That is, it is assumed that the knowledge database 102 stores the rules shown in the knowledge database B. The observation logical expression 101 is a logical expression represented by the observation logical expression O. The abductive inference device 107 receives the rule and the logical expression as inputs.

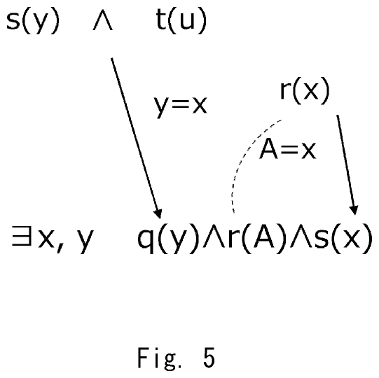

In response to this input, the candidate hypothesis generation unit 103 generates the set of candidate hypotheses as follows. First, the candidate hypothesis generation unit 103 applies s(x)∧t(y)→q(x) in the knowledge database in reverse to q(y) of the hypothesis logical expression, so that s(y)∧t(u) is added to the candidate hypotheses. The candidate hypothesis generation unit 103 introduces u as a variable unrelated to a variable y. The candidate hypothesis generation unit 103 repeats the reverse application to ultimately create the set of candidate hypotheses shown in FIG. 5.

The following logical variables are introduced for each element included in the set of candidate hypotheses. In the following descriptions, p and q are specified literals in the set of candidate hypotheses.
hₚ: True if the hypothesis includes the literal p.
rₚ: True if the literal p pays no cost.
u_{p,q}: True if the literal p is unified with the literal q.

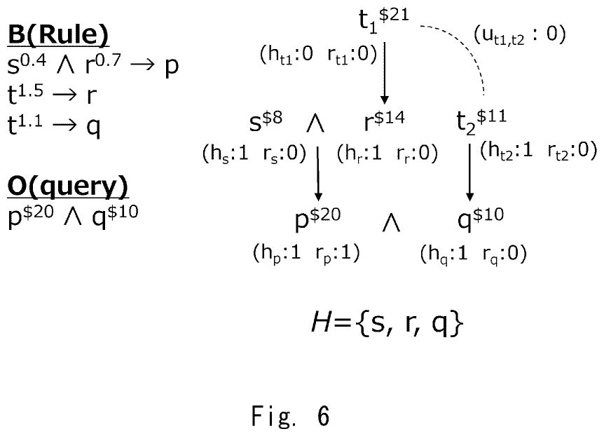

For example, as shown in FIG. 6, when the knowledge database B (rule) and the observation logical expression O (query) are given, the candidate hypothesis generation unit 103 introduces the above variables (e.g., a storage area pointed to by the variable) to the generated set of candidate hypotheses, and stores values such as (hₚ:T rₚ:T), (hₛ:T rₛ:F), (hᵣ:T rᵣ:F), (hₜ₁:F rₜ₁:F), (hₜ₂:T rₜ₂:F), (h_{q}:T r_{q}:F), and (u_{t1,t2}: F) for the respective variables. This represents the hypothesis H={s, r, q}. Details of the hypotheses and the assignment of the truth value of each variable are disclosed in, for example, Non Patent Literature 1.

However, if the truth value is not correctly assigned to each variable, an unsatisfied solution is generated. As an example, H′={s, p} is a poor solution and s is generated by applying the “s ∧ r→p” rule in reverse. At the same time, r is also generated. The H′={s, p} used in the example does not mean that another literal is generated by applying another rule to the originally generated r, and r is not an element of H′. Thus, H′ is not generated as a hypothesis generated by applying the rules in the knowledge database in reverse to the observation logical expression.

Next, the processing in the SAT conversion unit 104 will be described.

Therefore, in order to satisfy the nature of the solution as a hypothesis, it is necessary to consider constraints as follows. The following constraints 1 and 3 can be described as constraints of Partial Weighted MAX SAT. First, the constraints are explained within a range of the propositional logic.

Constraint 1: “The literal included in the observation is always included or explained in the candidate hypothesis.”

For each pϵ observation O, the constraint logical expression: hₚ

Constraint 2: “When a literal in a hypothesis pays no cost, it is when the literal is described by another literal or when the literal is unified.”

“When literals that may be explained are connected by and, all of the literals are included in the candidate hypotheses or none of the literals are included in the candidate hypotheses.”

For each pϵ hypothesis P, the constraint logical expression is as follows:

¬rₚ [symbol] hₑ [symbol] u_{p,q}

e ∈expl(p) q∈sml(p)

[symbol]

hₐ [symbol] ¬hₐ

a∈and(p) a∈and(p) [Expression 1]

In this expression, B is a set of rules included in the knowledge database.

expl(p)={e|eϵP, {e}∨B|=p}

sml(p)={q|qϵP, c(q)<c(p)}

Further, c(p) represents the cost assigned to the literal p, and

and(p) is a literal that can explain p and represents a literal aϵP connected by and.

Constraint 3: “When unified, all the literals that are unified are hypothesized”

For each p, qϵ hypothesis P, the constraint logical expression:

(¬u_{p,q} ∨ hₚ) ∧ (¬u_{p,q} ∨ h_{q})

Next, the constraints will be described in the range of the first-order predicate logic.
Regarding a variable xϵV of the argument of the literal, and a constant or variable yϵ(V ∨ C), the following is given.
s_{x,y}=True (when y is assigned to x)

False (otherwise)

Constraint 4: “All arguments of the literals to be unified are equal” For the set of variable assignments u_{p, q} needed to unify the literals p and q, the constraint logical expression is:

$${u}_{p , q} \to {⩓ {S}_{x , y}}_{\{ x , y \} ∈ usub ( p , q )} . \qquad [ Expression 2 ]$$

Constraint 5: “No more than one constant can be assigned to a variable at a time”

$${⩔}_{i = 0}^{\vert U \vert} {⩓}_{j = 0}^{\vert U \vert} \{ \begin{matrix}{s}_{x , uj} & ( i = j ) \\ ⫬ {s}_{x , uj} & ( i \neq j )\end{matrix} \} . \qquad [ Expression 3 ]$$

Constraint 6: “Transitive law between three variables”

Constraint logical expressions:

¬s_{x,y} ∨ ¬s_{y,z} ∨ s_{x,z}

¬s_{x,z} ∨ ¬s_{x,y} ∨ s_{y,z}

¬s_{y,z} ∨ ¬s_{x,z} ∨ s_{x,y}

The SAT constraint expression actually created based on the above is as follows.

h_{q(y)} Constraint 1:

¬rₛ₍ₓ₎∨hᵣ₍ₓ₎, ¬r_{q(y)}∨h_{s(y)}∨hₜ₍ᵤ₎; h_{s(y)}∨hₜ₍ᵤ₎ Constraint 2:

(¬u_{r(x),r(A)}∨hᵣ₍ₓ₎)∨(¬u_{r(x),r(A)}∨h_{r(A)}), (¬u_{s(y),s(x)} ∨h_{s(y)})∧(¬u_{s(y),s(x)}∨hₛ₍ₓ₎) Constraint 3:

u_{r(x),r(A)}→s_{x,A} Constraint 4:

(s_{x,A}∧¬s_{x,B})∨(¬s_{x,A}∧s_{x,B}) Constraint 5:

¬s_{y,A} ∨¬s_{x,A} ∨s_{x,y}

¬s_{x,A} ∨¬s_{x,y} ∨s_{y,A}

¬s_{x,A} ∨¬s_{x,y} ∨s_{y,A} Constraint 6:

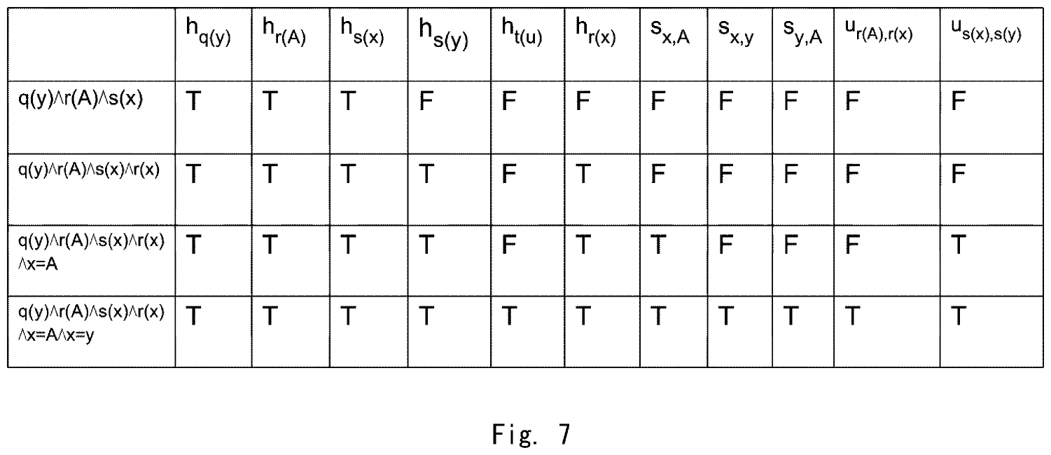

For these constraints, a truth value table for each Boolean variable is shown in FIG. 7. Therefore, the SAT conversion unit 104 creates information representing the constraint condition from the hypothesis created by the candidate hypothesis generation unit 103 in accordance with the above-described processing, and uses the created information representing the constraint to create the following logical formula.

Logical formula φ={(¬(h_{q(y)}∧¬r_{q(y)}), cost(q(y))), (¬(h_{r(A)}∨¬r_{r(A)}), cost(r(A))), . . . , (h_{q(y)}, ∞), (¬rₛ₍ₓ₎∨hᵣ₍ₓ₎, ∞), . . . , (¬s_{x,A} ∨s_{x,y} ∨s_{y,A}, ∞)}

This is the information expressed in the format used in the Weighted Partial MaxSAT problem. That is, the SAT conversion unit 104 converts the hypothesis created by the candidate hypothesis generation unit 103 into the Weighted Partial MaxSAT problem. Thus, the SAT conversion unit 104 identifies the constraints satisfying the above-mentioned constraints 1 to 6, and assigns the weights corresponding to the identified constraints. In the example described above, the SAT conversion unit 104 assigns the sufficiently large weight (i.e., the weight for a hard clause that must be satisfied, represented schematically as “∞”) for the constraints 1, 2, and 6. In other words, these constraints may be logical expressions that are treated as hard constraints.

The SAT conversion unit 104 assigns the cost of deriving each constraint as a weight (i.e., weights for soft clauses that are not necessarily satisfied) for the constraints 3, 4, and 5. In other words, these constraints may be logical expressions that are treated as soft constraints.

Thus, the SAT conversion unit 104 creates a logical expression to be treated as a hard constraint and a logical expression to be treated as a soft constraint based on the set of candidate hypotheses, and converts the created logical expression into the optimization problem (i.e., the Weighted Partial MaxSAT problem) including this logical expression as the constraint condition.

The SAT conversion unit 104 inputs the created information to the SAT solver 105.

The SAT solver 105 calculates a “q(y)∧r(A)∧s(x)∧r(x)∧x=A” of the best hypothesis from the input information. That is, the SAT solver 105 generates a plausible hypothesis using the hypothesis created by the candidate hypothesis generation unit 103. The optimum solution output by the SAT solver 105 is, for example, the best hypothesis. Thus, the SAT solver 105 calculates a hypothesis when a predetermined condition is satisfied for the optimization problem.

### Second Example Embodiment

A second example embodiment of the present disclosure will be described below with reference to the drawings.

### [Description of Configuration]

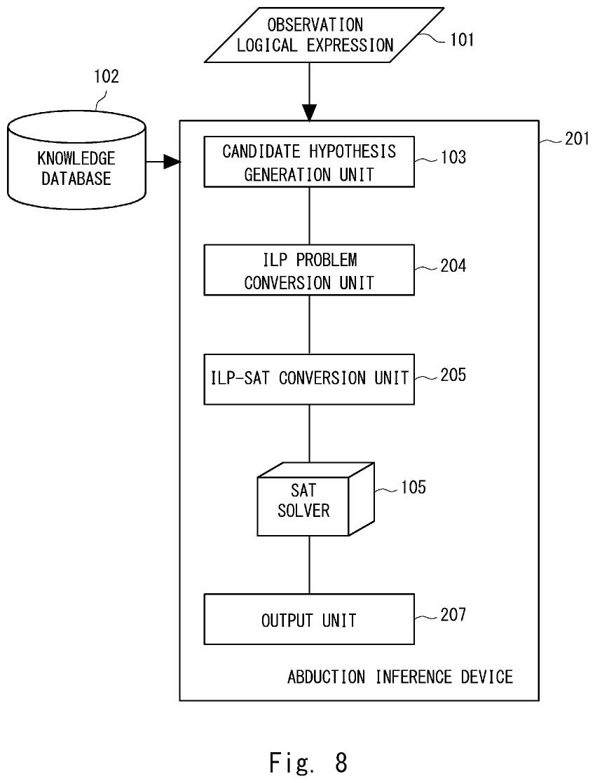

FIG. 8 is a schematic diagram showing a configuration of an abductive inference device 201 according to the second example embodiment. As shown in FIG. 8, the abductive inference device 201 includes a candidate hypothesis generation unit 103, an ILP problem conversion unit 204, an ILP-SAT conversion unit 205, a SAT solver 105, and an output unit 207. The abductive inference device 201 receives an observation logical expression 101 as an input. The abductive inference device 201 is connected to the knowledge database 102 to enable the exchange of data therebetween.

The ILP problem conversion unit 204 converts a set of candidate hypotheses derived by the candidate hypothesis generation unit 103 into an ILP problem. The conversion method to the ILP problem is, for example, a method described in Non Patent Literature 1. The conversion method to the ILP problem is not limited to the above. The ILP-SAT conversion unit 205 converts the ILP problem into the Weighted Partial MaxSAT problem as described above. The conversion method is described in, for example, Non Patent Literature 2. The conversion method is not limited to the example described above.

The SAT solver 105 solves the SAT problem acquired by the ILP-SAT conversion unit, and outputs the best hypothesis from the acquired optimum solution in the best hypothesis output unit.

### [Description of Operation]

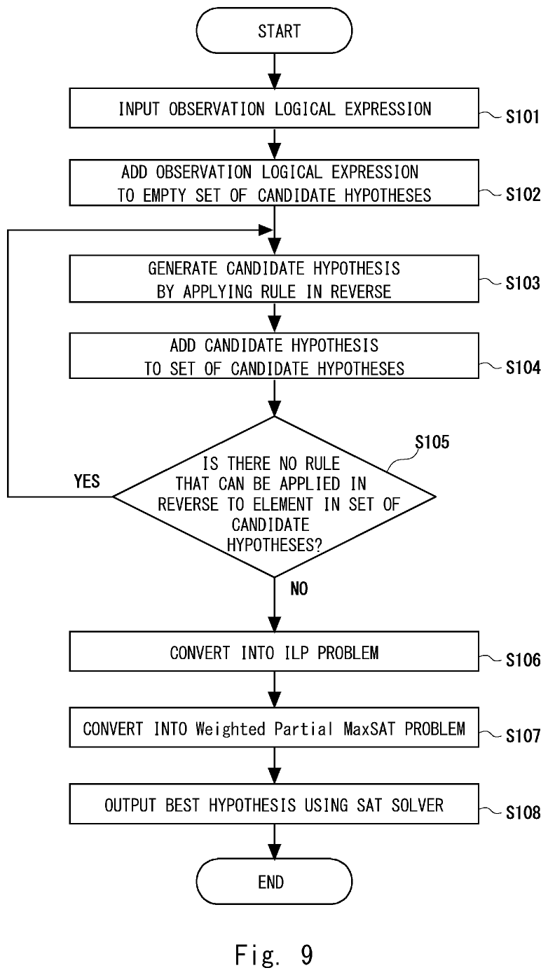

FIG. 9 is a flowchart showing an operation of the abductive inference device according to the second example embodiment for implementing the present disclosure.

As shown in FIG. 9, the candidate hypothesis generation unit 103 receives the observation logical expression as the input (Step S101). Next, the candidate hypothesis generation unit 103 adds the observation logical expression to the set of candidate hypotheses (Step S102). The set of candidate hypotheses may be stored in, for example, the storage unit (not shown). It is also assumed that the set of candidate hypotheses is initialized in advance by an empty set.

Next, the candidate hypothesis generation unit 103 applies the rule in reverse to the elements in the set of candidate hypotheses (Step S103). Information representing the initialized set of candidate hypotheses is stored in advance in the storage unit (not shown). The candidate hypothesis generation unit 103 may store, in the storage unit (not shown), information representing the set of candidate hypotheses to which the observation logical expression has been added. Note that the candidate hypothesis generation unit 103 may store the information representing the created set of candidate hypotheses in the storage unit (not shown).

Next, the candidate hypothesis generation unit 103 adds the generated candidate hypothesis to the set of candidate hypotheses (Step S104). The candidate hypothesis generation unit 103 inputs the created set of candidate hypotheses to the ILP problem conversion unit 204.

Next, the candidate hypothesis generation unit 103 determines whether or not there is no longer a rule in the knowledge database 102 that can be applied in reverse to the elements in the set of candidate hypotheses (Step S105). If there is no longer a rule in the knowledge database that can be applied in reverse to the elements in the set of candidate hypotheses (in the case of NO), the process proceeds to the next Step S106, whereas if there is a rule(s) in the knowledge database that can be applied in reverse to the elements in the set of candidate hypotheses (in the case of YES), the process returns to Step S103.

The ILP problem conversion unit 204 converts the acquired set of candidate hypotheses into the ILP problem (Step S106), and inputs the converted ILP problem to the ILP-SAT conversion unit 205.

The ILP-SAT conversion unit 205 converts the ILP problem into the Weighted Partial MaxSAT problem (Step S107), and inputs the converted problem to the SAT solver 105.

The SAT solver 105 outputs the best hypothesis by performing the processing described above with reference to FIG. 3 for the problem (Step S108).

### EXAMPLE 2

Only the ILP problem conversion unit 204 and the ILP-SAT conversion unit 205, which are different from Example 1, will be described.

The given knowledge database B and the observation logical expression O are the same as those in Example 1. First, the ILP problem conversion unit 204 creates an ILP constraint for the candidate hypothesis created by the candidate hypothesis generation unit 103 in accordance with Non Patent Literature 1 as follows.

hq(y)=1 Constraint 1:

rs(x)≤hr(x); hs(y)=ht(u), 2r_{q(y)}≤h_{s(y)}+hₜ₍ᵤ₎ Constraint 2:

2ur(x), r(A)≤hr(x)+hr(A), 2us(y), s(x)≤hs(y)+hs(x) Constraint 3:

ur(x), r(A)≤sx,A Constraint 4:

sx,A+sx,B≤1 Constraint 5:

sy,A−sx,A−sx,y≥−1 Constraint 6:

The ILP-SAT conversion unit 205 converts these ILP constraint expressions into the SAT constraints of Example 1 based on Non Patent Literature 2. This allows input to the SAT solver 105.

Note that the present disclosure is not limited to the above-described example embodiments, and may be modified as appropriate without departing from the spirit of the disclosure.

As described above, according to the present disclosure, it is possible to perform abductive inference at a high speed, and thus a large-scale knowledge database can be used, and it is possible to handle a large-scale observation.

For example, in the field of computer security, the created hypothesis can be used to determine the rule for detecting malware or a process for detecting malware. In this case, the knowledge database 102 stores information representing given knowledge such as, for example, “when a program opens a file that manages accounts, the program connects to a communications network”. The abductive inference device 107 creates a hypothesis for deriving an observation logical expression (e.g., a logical expression of “a program is malware”). The abductive inference device 107 may determine whether or not each logical expression constituting the created hypothesis holds true. The abductive inference device 107 determines that the certain program is malware when the logical expression included in the hypothesis holds true. In this case, the abductive inference device 107 can check computer security for this program.

For example, when a device composed of a plurality of components fails, the hypothesis created by the abductive inference device 107 may also be used to identify the component related to the failure. In this case, the knowledge database 102 stores information representing given knowledge such as, “a failure of a device reduces the amount of production produced by that device”. In this case, the observation logical expression is, for example, a logical expression representing “this device has failed”. The abductive inference device 107 may determine whether or not each logical expression constituting the created hypothesis holds true. The abductive inference device 107 determines that the device has failed when the logical expression included in the hypothesis is established. In this case, the abductive inference device 107 can identify the component that has failed in the device.

The field in which the hypothesis created by the abductive inference can be used is not limited to computer security, a fault diagnosis device, or the like.

In the above example embodiments, the present disclosure has been described as a hardware configuration, but the present disclosure is not limited to this. The present disclosure can also be implemented by causing a CPU (Central Processing Unit) to execute a control program for each process.

The control program for implementing the abductive inference method described above can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM), PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication.

Although the present disclosure has been described above with reference to the example embodiments, the present disclosure is not limited by the above. Various modifications that can be understood by those skilled in the art within the scope of the disclosure can be made to the configuration and details of the present disclosure.

This application is based upon and claims the benefit of priority from Japanese patent application No. 2018-119771, filed on Jun. 25, 2018, the disclosure of which is incorporated herein in its entirety by reference.

### REFERENCE SIGNS LIST

1 ABDUCTIVE INFERENCE DEVICE
2 HYPOTHESIS GENERATION UNIT
3 CONVERSION UNIT
4 SOLVER UNIT
101 OBSERVATION LOGICAL EXPRESSION
102 KNOWLEDGE DATABASE
103 CANDIDATE HYPOTHESIS GENERATION DEVICE
104 CONVERSION UNIT
105 SOLVER
106 HYPOTHESIS OUTPUT UNIT
107 ABDUCTIVE INFERENCE DEVICE
201 ABDUCTIVE INFERENCE DEVICE
204 PROBLEM CONVERSION UNIT
205 ILP-SAT CONVERSION UNIT
207 OUTPUT UNIT

What is claimed is:

1. An abductive inference device comprising:
at least one memory storing program instructions; and
at least one processor configured to execute the instructions stored in the memory to:
create a set of candidate hypotheses, observed information including a hypothesis from which a logical expression is derived based on a knowledge database including knowledge information expressing the logical expression for deriving a consequent from an antecedent;
calculate a constraint condition for the created set of candidate hypotheses and a weight for the constraint condition in accordance with predetermined processing; and
calculate the hypothesis when a predetermined condition is satisfied based on the calculated constraint condition and the calculated weight.

2. The hypothesis inference device according to claim 1, wherein
in the calculation of the constraint condition for the created set of candidate hypotheses and the weight for the constraint condition in accordance with the predetermined processing, based on the logical expression in the set of candidate hypotheses, the constraint condition that must be satisfied and the constraint condition that does not necessarily need to be satisfied are created in accordance with the predetermined processing, and
in the calculation of the hypothesis when the predetermined condition is satisfied, the hypothesis when the predetermined condition is satisfied is calculated based on the created constraint condition.

3. The abductive inference device according to claim 1, wherein
in the calculation of the constraint condition for the created set of candidate hypotheses and the weight for the constraint condition in accordance with the predetermined processing,
the processor is further configured to execute the instructions to
convert a candidate hypothesis into an integer linear programming problem; and
convert the integer linear programming problem converted by the ILP problem conversion means into the logical expression treated as a hard constraint and the logical expression treated as a soft constraint.

4. An abductive inference method comprising:
creating a set of candidate hypotheses, observed information including a hypothesis from which a logical expression is derived based on a knowledge database including knowledge information expressing the logical expression for deriving a consequent from an antecedent;
calculating a constraint condition for the created set of candidate hypotheses and a weight for the constraint condition in accordance with predetermined processing; and
calculating the hypothesis when a predetermined condition is satisfied based on the calculated constraint condition and the calculated weight.

5. The abductive inference method according to claim 4, wherein:
in the calculating of the constraint condition for the created set of candidate hypotheses and the weight for the constraint condition in accordance with the predetermined processing, the constraint condition that must be satisfied and the constraint condition that does not necessarily need to be satisfied are created based on the logical expression in the set of candidate hypotheses in accordance with the predetermined processing, and
in the calculating of the hypothesis when the predetermined condition is satisfied, the hypothesis when the predetermined condition is satisfied is calculated based on the created constraint condition.

6. The abductive inference method according to claim 4, wherein the calculating of the constraint condition for the created set of candidate hypotheses and the weight for the constraint condition in accordance with the predetermined processing further comprises:
converting a candidate hypothesis into an integer linear programming problem; and
converting the integer linear programming problem converted into the logical expression treated as a hard constraint and the logical expression treated as a soft constraint.

7. A non-transitory computer readable medium storing a program causing a computer to execute:
creating a set of candidate hypotheses, observed information including a hypothesis from which a logical expression is derived based on a knowledge database including knowledge information expressing the logical expression for deriving a consequent from an antecedent;
calculating a constraint condition for the created set of candidate hypotheses and a weight for the constraint condition in accordance with predetermined processing; and
calculating the hypothesis when a predetermined condition is satisfied based on the calculated constraint condition and the calculated weight.

8. A non-transitory computer readable medium storing the program according to claim 7, wherein,
in the calculating of the constraint condition for the created set of candidate hypotheses and the weight for the constraint condition in accordance with the predetermined processing, the constraint condition that must be satisfied and the constraint condition that does not necessarily need to be satisfied are created based on the logical expression in the set of candidate hypotheses in accordance with the predetermined processing, and
in the calculating of the hypothesis when the predetermined condition is satisfied, the hypothesis when the predetermined condition is satisfied is calculated based on the created constraint condition.

9. A non-transitory computer readable medium storing the program according to claim 7, wherein the calculating of the constraint condition for the created set of candidate hypotheses and the weight for the constraint condition in accordance with the predetermined processing further comprises:
converting a candidate hypothesis into an integer linear programming problem; and
converting the integer linear programming problem converted into the logical expression treated as a hard constraint and the logical expression treated as a soft constraint.
